(19) United States
(12) Patent Application Publication
(10) Pub. No.: US 2016/0266846 A1
(43) Pub. Date: Sep. 15, 2016

(54) COMMUNICATION APPARATUS AND MEMORY CONTROL METHOD

(71) Applicant: KABUSHIKI KAISHA TOSHIBA, Tokyo (JP)

(72) Inventor: Tomoya HORIGUCHI, Inagi Tokyo (JP)

(73) Assignee: KABUSHIKI KAISHA TOSHIBA, Tokyo (JP)

(21) Appl. No.: 14/846,328

(22) Filed: Sep. 4, 2015

(30) Foreign Application Priority Data
Mar. 12, 2015 (JP) 2015-049796

(51) Int. Cl. G06F 3/06; H04B 5/00; H04L 12/861

(52) U.S. Cl. CPC G06F 3/0656; G06F 3/0611; G06F 3/0659; G06F 3/067; H04L 49/9005; H04B 5/0031

(57) ABSTRACT

A controller can perform a first write process, in which the controller confirms a state of a buffer memory in response to a first interrupt signal, and if the buffer memory has a free space where next transmission data can be written, writes the next transmission data in the buffer memory. Further, the controller can perform a second write process, in which the controller confirms the state of the buffer memory in response to completion of the first write process, and if the buffer memory has the free space, writes the next transmission data in the buffer memory. The controller performs a new one of the first write process after having performed write of the transmission data in the second write process.

### CROSS REFERENCE TO RELATED APPLICATIONS

This application is based upon and claims the benefit of priority from the prior Japanese Patent Application No. 2015-49796, filed on Mar. 12, 2015, the entire contents of which are incorporated herein by reference.

### FIELD

Embodiments of the present invention relate to a communication apparatus and a memory control method.

### BACKGROUND

Conventionally, as one of wireless communication techniques, Near Field Communication has been known. For example, in the TransferJet®, by holding a device of its own over a counterpart device, to which it is desired to transfer data, the data can be transferred to the counterpart device, while omitting complicated setting unique to the wireless communication.

However, in the conventional wireless communication techniques, it has been difficult to transfer data (that is, to perform data communication) quickly, while suppressing a delay due to processing other than the data transfer.

### BRIEF DESCRIPTION OF THE DRAWINGS

FIG. 1 is a block diagram of a communication system 1 according to the present embodiment;

FIG. 2 is a flowchart showing a transmission operation of a communication apparatus 10 in the communication system 1 shown in FIG. 1;

FIG. 3 is a flowchart showing a reception operation of the communication apparatus 10 in the communication system 1 shown in FIG. 1; and

FIG. 4 is a state transition diagram of a controller 12 in the communication apparatus 10 of the communication system 1 shown in FIG. 1.

### DETAILED DESCRIPTION

A communication apparatus according to an embodiment comprises a transmission device and a controller. The controller writes transmission data to be transmitted to a communication counterpart apparatus in a buffer memory in which the transmission data is written. The transmission device reads the transmission data from the buffer memory and transmits the transmission data to the communication counterpart apparatus. The transmission device outputs a first interrupt signal to the controller in response to transmission completion of the transmission data. The controller can perform a first write process in which the controller confirms a state of the buffer memory in response to the first interrupt signal, and if the buffer memory has a free space where next transmission data can be written, writes the next transmission data in the buffer memory. The controller can perform a second write process in which the controller confirms the state of the buffer memory in response to completion of the first write process, and if the buffer memory has the free space, writes the next transmission data in the buffer memory. The controller performs a new one of the first write process after having performed write of the transmission data in the second write process.

Embodiments will now be explained with reference to the accompanying drawings. The present invention is not limited to the embodiments.

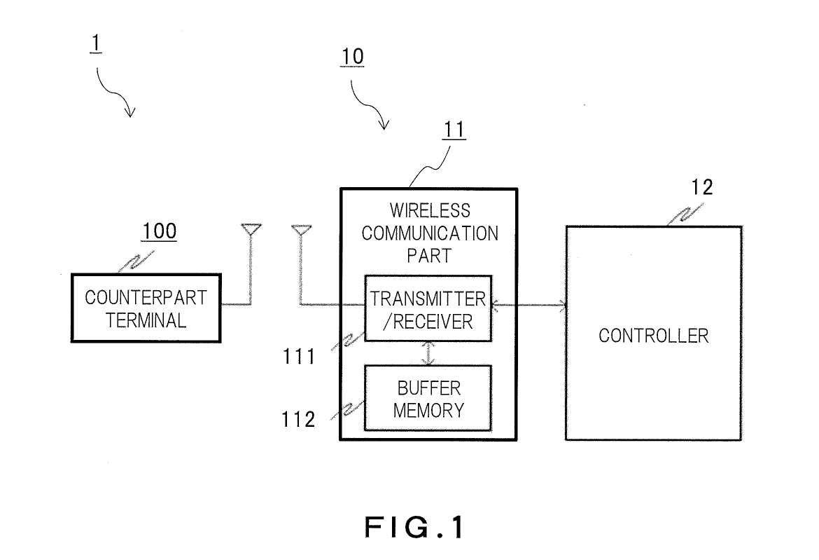

FIG. 1 is a block diagram of a communication system 1 according to the present embodiment. The communication system 1 includes a communication apparatus 10, that is, a semiconductor device and a counterpart terminal 100. The counterpart terminal 100 is a communication counterpart apparatus, a first communication counterpart apparatus, or a second communication counterpart apparatus.

The communication apparatus 10 is incorporated in a portable electronic apparatus, for example, a mobile phone, a smartphone, a tablet terminal, a laptop computer, and a digital camera. The communication apparatus 10 can be incorporated in a fixed electronic apparatus, for example, a desktop computer, a server, or an image reproduction apparatus.

The communication apparatus 10 can be an adapter detachably connected to a connector (for example, a USB connector) of, for example, the electronic apparatus. A mode of the communication apparatus 10 is not limited to those described above, and for example, the communication apparatus 10 can be undetachably incorporated in the electronic apparatus. The counterpart terminal 100 can be a portable or fixed terminal, and can be equipped with a communication apparatus similar to the communication apparatus 10.

As shown in FIG. 1, the communication apparatus 10 includes a wireless communication part 11 and a controller 12. The controller 12 can be configured by, for example, a CPU, a ROM, and a RAM. The wireless communication part 11 includes a transmitter/receiver 111 and a buffer memory 112. The transmitter/receiver 111 is also a transmission device. Further, the transmitter/receiver 111 is also a reception device. The transmitter/receiver 111 can function as either the transmission device or the reception device.

The transmitter/receiver 111 performs data communication with the counterpart terminal 100, for example, by the Near Field Communication. A mode of the Near Field Communication can be such that a high frequency signal is transmitted and received by electric field coupling, for example, between a coupling electrode of the transmitter/receiver 111 and a coupling electrode of the counterpart terminal 100. The Near Field Communication can be, for example, the TransferJet.

Transmission data to be transmitted to the counterpart terminal 100 is written in the buffer memory 112. Reception data received from the counterpart terminal 100 is also written in the buffer memory 112.

The transmitter/receiver 111 reads the transmission data from the buffer memory 112 and transmits the transmission data to the counterpart terminal 100. Further, the transmitter/receiver 111 receives the reception data from the counterpart terminal 100 and writes the reception data in the buffer memory 112.

The controller 12 writes the transmission data in the buffer memory 112. Further, the controller 12 reads the reception data from the buffer memory 112.

The controller 12 can access the transmitter/receiver 111 asynchronously to write the transmission data in the buffer memory 112 via the transmitter/receiver 111 (or by controlling the transmitter/receiver 111). Further, the controller 12 can access the transmitter/receiver 111 asynchronously to read the reception data from the buffer memory 112 via the transmitter/receiver 111 (or by controlling the transmitter/receiver 111).

The transmitter/receiver 111 outputs a first interrupt signal permitting write of the next transmission data to the controller 12 in response to transmission completion of the transmission data. Further, the transmitter/receiver 111 outputs a second interrupt signal permitting read of the next reception data to the controller 12 in response to reception completion of the reception data.

The controller 12 can selectively perform a first write process and a second write process. The first write process here is a process in which a state of the buffer memory 112 is confirmed in response to the first interrupt signal, and if the buffer memory 112 has a free space where the next transmission data can be written, the next transmission data is written N₁ times (at least once) in the buffer memory 112. However, N₁ is a natural number (the same applies hereinafter). N₁ times can be, for example, once. The second write process is a process in which the state of the buffer memory 112 is confirmed in response to completion of the first write process, and if the buffer memory 112 has a free space, the next transmission data is written in the buffer memory 112. Completion of the first write process means that the transmission data has been actually written in the buffer memory 112 by the first write process. Completion of the first write process can be also said to be completion (success) of write of the transmission data by the first write process. Therefore, if the transmission data cannot be written in the buffer memory 112 because there is no free space, the first write process has not been completed yet. As described above, the second write process is started upon completion of the first write process, while the first write process is started upon reception (input) of the first interrupt signal. Therefore, in the second write process, reception of the first interrupt signal can be omitted.

The first write process is also a process in which the next transmission data is not written in the buffer memory 112, if the buffer memory 112 does not have a free space, in the confirmation of the state of the buffer memory 112 in response to the first interrupt signal. Further, the second write process is also a process in which the next transmission data is not written in the buffer memory 112, if the buffer memory 112 does not have a free space, in the confirmation of the state of the buffer memory 112 in response to completion of the first write process.

Transmission of transmission data by the second write process can be a polling process.

The controller 12 performs a new one of the first write process, after write of transmission data by the first or second write process has been performed N₂ times in total. However, N₂ is a natural number equal to or larger than N₁ (the same applies hereinafter). For example, the controller 12 can perform write of transmission data by the first write process once, and then can perform the new first write process after write of transmission data by the second write process has been performed N₂-1 times.

If data transmission depending on only the first write process is to be performed, the controller 12 cannot write transmission data in the buffer memory 112, until the first interrupt signal is received from the transmitter/receiver 111. Therefore, transmission of the transmission data is delayed because the transmission data cannot be written in the buffer memory 112. On the other hand, according to the present embodiment, the second write process that does not require reception of the first interrupt signal can be performed, and thus the transmission data can be transmitted quickly. That is, transmission throughput can be improved.

On the other hand, if data transmission depending on only the second write process is to be performed, the controller 12 needs to confirm the state of the buffer memory 112 all the time for the second write process, and thus tasks other than write of the transmission data cannot be executed. Therefore, if data transmission depending on only the second write process is to be performed, execution of other tasks will be delayed. On the other hand, according to the present embodiment, the process can be switched to the first write process after the second write process. Accordingly, the delay of execution of other tasks can be suppressed (reduced).

N₂ times can be either constant or variable.

For example, in the controller 12, a transmission frame, whose transmission has been requested from a high order layer, may be divided into a plurality of packets and sequentially transmitted as data (transmission data) in a unit of packet. When the transmission frame is to be transmitted in a unit of packet, N₂ times can be the number of write of transmission data required for transmission completion of the entire transmission frame. In this case, the controller 12 can set N₂ times based on information relating to the number of transmission packets in a header of the transmission frame. By setting N₂ times as the number of write required for transmission completion of the entire transmission frame, the transmission frame can be transmitted quickly.

Further, when the confirmation of the state of the buffer memory 112 has been performed N₃ times, if the buffer memory 112 does not have a free space in all the confirmations performed N₃ times, the controller 12 can perform a new one of the first write process without performing the second write process. However, N₃ is a natural number equal to or larger than N₁ (the same applies hereinafter).

If the buffer memory 112 does not have a free space continuously, an execution opportunity of other tasks can be ensured by omitting the second write process and shifting to the first write process. Further, because the second write process can be omitted according to a confirmation result of the state of the buffer memory 112, a process of acquiring the transmission throughput can be omitted. On the other hand, because an opportunity of confirming the free space of the buffer memory 112 can be ensured plural times, the controller 12 can wait for an opportunity to transmit transmission data quickly in the second write process.

The controller 12 can acquire the transmission throughput of the transmitter/receiver 111 and set (change) N₃ times according to the transmission throughput.

For example, if the transmission throughput is high, the transmission data written in the buffer memory 112 can be transmitted immediately. In other words, if the transmission throughput is high, it can be said that there is a low possibility that the previous transmission data remains in the buffer memory 112 at the time of write of the transmission data. Because the previous transmission data does not remain in the buffer memory 112, the next transmission data can be immediately written in the buffer memory 112. Therefore, when the transmission throughput is higher than a first transmission threshold, the controller 12 can set N₃ times to N₁+1 times. N₁+1 times can be, for example, twice. In a state where the transmission throughput is high, by setting the number of confirmations of the buffer memory 112 to N₁+1 times, transmission data can be transmitted quickly and reliably, and the execution opportunity of other tasks can be ensured promptly.

On the other hand, if the transmission throughput is low, it can be said that there is a high possibility that the previous transmission data remains in the buffer memory 112 at the time of write of the transmission data. Because the previous transmission data remains in the buffer memory 112, the next transmission data cannot be written in the buffer memory 112 immediately. Therefore, when the transmission throughput is lower than a second transmission threshold, which is lower than the first transmission threshold, the controller 12 can set N₃ times to N₁ times. Setting N₃ times to N₁ times means also performing a new one of the first write process without performing the second write process. In a state where the transmission throughput is low, by avoiding the useless second write process having a low success rate, the execution opportunity of other tasks can be ensured promptly.

Furthermore, the controller 12 basically sets N₂ times to the number of write of transmission data required for transmission completion of the entire transmission frame, and exceptionally, if the transmission throughput is lower than the second transmission threshold, can set (change) N₂ times to N₁ times. By setting N₂ times to N₁ times, even if write by the first write process is successful, the next write process does not become the second write process, but becomes a new one of the first write process. Accordingly, an unstable write process (frame transmission) in a state where the transmission throughput is low is interrupted, thereby enabling to ensure the execution opportunity of other tasks promptly.

Further, the controller 12 can selectively perform a first read process and a second read process. The first read process here is a process in which the state of the buffer memory 112 is confirmed in response to the second interrupt signal, and if the buffer memory 112 has the next reception data, the next reception data is read from the buffer memory 112 N₄ times (at least once). However, N₄ is a natural number (the same applies hereinafter). N₄ times can be, for example, once. The second read process is a process in which the state of the buffer memory 112 is confirmed in response to completion of the first read process, and if the buffer memory 112 has the next reception data, the next reception data is read from the buffer memory 112. Completion of the first read process means that the reception data has been actually read from the buffer memory 112 by the first read process. Completion of the first read process can be said to be completion (success) of read of the reception data by the first read process. Therefore, if the reception data cannot be read from the buffer memory 112 because there is no reception data in the buffer memory 112, the first read process has not been completed yet. As described above, the second read process is started upon completion of the first read process, while the first read process is started upon reception (input) of the second interrupt signal. Therefore, in the second read process, reception of the second interrupt signal can be omitted.

The first read process is also a process in which the next reception data is not read from the buffer memory 112, if the buffer memory 112 does not have the next reception data, in the confirmation of the state of the buffer memory 112 in response to the second interrupt signal. Further, the second read process is also a process in which the next reception data is not read from the buffer memory 112, if the buffer memory 112 does not have the next reception data, in the confirmation of the state of the buffer memory 112 in response to completion of the first read process performed N₄ times.

Reception of reception data by the second read process can be a polling process.

The controller 12 performs a new one of the first read process, after read of reception data by the first or second read process has been performed N₅ times in total. However, N₅ is a natural number equal to or larger than N₄ (the same applies hereinafter). For example, the controller 12 can perform read of reception data by the first read process once, and then can perform the new first read process after read of reception data by the second read process is performed N₅−1 times.

If data reception depending on only the first read process is to be performed, the controller 12 cannot read reception data from the buffer memory 112, until the second interrupt signal is received from the transmitter/receiver 111. Therefore, reception of the reception data is delayed because the reception data cannot be read from the buffer memory 112. On the other hand, according to the present embodiment, the second read process, that does not require reception of the second interrupt signal can be performed, and thus the reception data can be received quickly. That is, reception throughput can be improved.

On the other hand, if data reception depending on only the second read process is to be performed, the controller 12 cannot execute other tasks during the second read process, and thus execution of other tasks is delayed. On the other hand, according to the present embodiment, after the second read process, the process can be switched to the first read process. Accordingly, the execution delay of other tasks can be suppressed (reduced).

N₅ times can be either constant or variable.

For example, in the controller 12, a reception frame may be sequentially received one by one for reception data in a unit of packet. When the reception frame is to be received in a unit of packet, N₅ times can be the number of read of reception data required until the last reception data in the reception frame has been read from the buffer memory 112. In this case, the controller 12 can set N₅ times based on information relating to the number of reception packets in a header of the reception frame. By setting N₅ times as the number of read required until the last reception data in the reception frame has been read, the reception frame can be received quickly.

Further, when the confirmation of the state of the buffer memory 112 has been performed N₆ times, if the buffer memory 112 does not have the next reception data in all the confirmations performed N₆ times, the controller 12 can perform a new one of the first read process without performing the second read process. However, N₆ is a natural number equal to or larger than N₄ (the same applies hereinafter).

If the buffer memory 112 does not have the next reception data continuously, the execution opportunity of other tasks can be ensured by omitting the second read process and shifting to the first read process. Further, because the second read process can be omitted according to a confirmation result of the state of the buffer memory 112, a process of acquiring the reception throughput can be omitted. On the other hand, because the opportunity of confirming the next reception data in the buffer memory 112 can be ensured plural times, the controller 12 can wait for an opportunity to receive reception data quickly in the second read process.

The controller 12 can acquire the reception throughput of the transmitter/receiver 111 and set (change) N₆ times according to the reception throughput.

For example, if the reception throughput is high, after the reception data has been read from the buffer memory 112, the next reception data can be received immediately and written in the buffer memory 112. Because the next reception data has been written in the buffer memory 112, the next reception data can be read from the buffer memory 112 immediately. Therefore, if the reception throughput is higher than a first reception threshold, the controller 12 can set N₆ times to N₄+1 times. N₄+1 times can be, for example, twice. In a state where the reception throughput is high, by setting the number of confirmations of the buffer memory 112 to N₄+1 times, reception data can be received quickly and reliably, and the execution opportunity of other tasks can be ensured promptly.

On the other hand, if the reception throughput is low, it can be said that there is a low possibility that after the reception data has been read from the buffer memory 112, the next reception data is received immediately and written in the buffer memory 112. Therefore, when the reception throughput is lower than a second reception threshold, which is lower than the first reception threshold, the controller 12 can set N₆ times to N₄ times. Setting N₆ times to N₄ times means performing a new one of the first read process without performing the second read process. In a state where the reception throughput is low, by avoiding the useless second read process having a low success rate, the execution opportunity of other tasks can be ensured promptly.

Further, the controller 12 basically sets N₅ times to the number of read of reception data required until the last reception data in the reception frame has been read, and exceptionally, if the reception throughput is lower than the second reception threshold, can set (change) N₅ times to N₄ times. By setting N₅ times to N₄ times, even if read by the first read process is successful, the next read process is not the second read process, but a new one of the first read process. Accordingly, an unstable read process (frame reception) in a state where the reception throughput is low is interrupted, thereby enabling to ensure the execution opportunity of other tasks promptly.

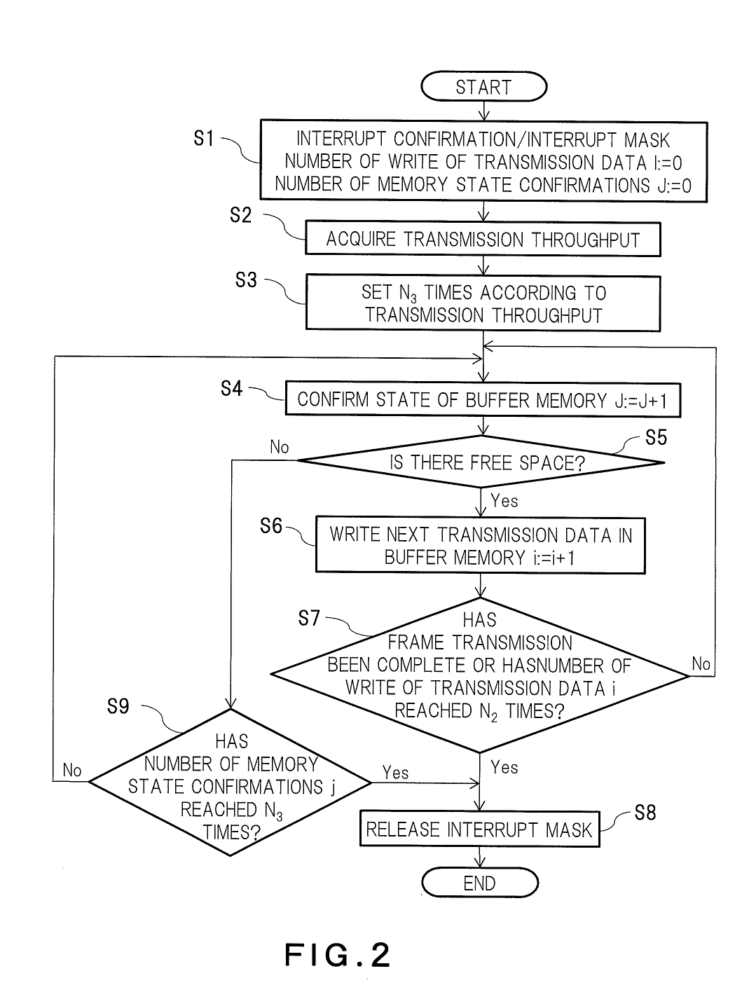

An example of a transmission operation of the communication apparatus 10 having the configuration as shown in FIG. 1 is described here. FIG. 2 is a flowchart showing the transmission operation of the communication apparatus 10 in the communication system 1 shown in FIG. 1, that is, a memory control method. In the flowchart in FIG. 2, the operation is based on N₁=1.

As shown in FIG. 2, the controller 12 first confirms reception of the first interrupt signal from the transmitter/receiver 111 (Step S1). The controller 12 then causes the transmitter/receiver 111 to forbid transmission of the first interrupt signal (mask an interrupt). At this time, the controller 12 sets the number of write of transmission data (the total number of write) i to 0, and sets the number of memory state confirmations (the number of state confirmations of the buffer memory 112) j to 0.

Next, the controller 12 acquires the transmission throughput (Step S2).

The controller 12 then sets N₃ times according to the transmission throughput (Step S3).

The controller 12 confirms the state of the buffer memory 112, that is, the free space thereof (Step S4). At this time, the controller 12 increments the number of memory state confirmations j and sets it to j+1.

Subsequently, the controller 12 determines whether the buffer memory 112 has the free space (Step S5). If the buffer memory 112 has the free space (YES at Step S5), the controller 12 writes the next transmission data in the buffer memory 112 (Step S6). At this time, the controller 12 increments the number of write of transmission data i and sets it to i+1. If the write of the next transmission data (Step S6) is performed in the first round, it is the write in the first write process. If the write of the next transmission data (Step S6) is performed in the second round or more, it is the write in the second write process.

On the other hand, if the buffer memory 112 does not have the free space (NO at Step S5), the controller 12 determines whether the number of memory state confirmations j has reached N₃ times (Step S9). If the number of confirmations j has reached N₃ times (YES at Step S9), the controller 12 releases the interrupt mask (Step S8). After release of the interrupt mask (Step S8), the controller 12 performs a new one of the first write process. On the other hand, if the number of confirmations j has not reached N₃ times (NO at Step S9), the controller 12 confirms the state of the buffer memory 112 again, and increments the number of confirmations j (Step S4).

After write of the next transmission data (Step S6), the controller 12 determines whether the frame transmission is complete or the number of write of transmission data i has reached N₂ times (Step S7). If the frame transmission is complete or the number of write of transmission data i has reached N₂ times (YES at Step S7), the controller 12 releases the interrupt mask (Step S8). On the other hand, if the frame transmission is not complete and the number of write of transmission data i has not reached N₂ times (NO at Step S7), the controller 12 confirms the state of the buffer memory 112 again (Step S4). If the confirmation of the state of the buffer memory 112 is performed in the second round or more, the confirmation is performed in the second write process.

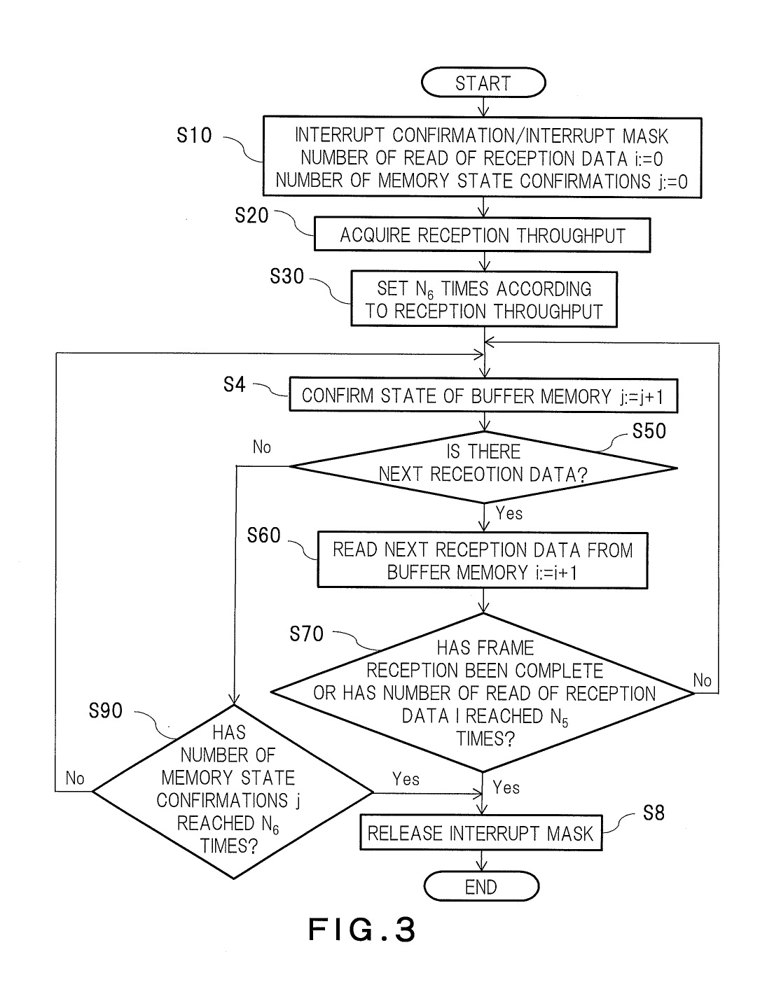

An example of a reception operation of the communication apparatus 10 having the configuration as shown in FIG. 1 is described next. FIG. 3 is a flowchart showing the reception operation of the communication apparatus 10 in the communication system 1 shown in FIG. 1, that is, the memory control method. In the flowchart in FIG. 3, the operation is based on N₄=1.

As shown in FIG. 3, the controller 12 confirms reception of the second interrupt signal from the transmitter/receiver 111 (Step S10). The controller 12 then sets the number of read of reception data (the total number of read) i to 0, and sets the number of memory state confirmations j to 0.

Next, the controller 12 acquires the reception throughput of the transmitter/receiver 111 (Step S20).

The controller 12 then sets N₆ times according to the reception throughput (Step S30).

The controller 12 then confirms the state of the buffer memory 112, that is, the presence of the next reception data (Step S4). The controller 12 then increments the number of memory state confirmations j and determines whether the buffer memory 112 has the next reception data (Step S50).

If the buffer memory 112 has the next reception data (YES at Step S50), the controller 12 reads the next reception data from the buffer memory 112 (Step S60). At this time, the controller 12 increments the number of read of reception data i and sets it to i+1. If the read of the next reception data (Step S60) is performed in the first round, it is the read in the first read process. If the read of the next reception data (Step S60) is performed in the second round or more, it is the read in the second read process.

On the other hand, if the buffer memory 112 does not have the next reception data (NO at Step S50), the controller 12 determines whether the number of memory state confirmations j has reached N₆ times (Step S90). If the number of confirmations j has reached N₆ times (YES at Step S90), the controller 12 releases the interrupt mask (Step S8). After release of the interrupt mask (Step S8), the controller 12 performs a new one of the first read process. On the other hand, if the number of confirmations j has not reached N₆ times (NO at Step S90), the controller 12 confirms the state of the buffer memory 112 again, and increments the number of confirmations j (Step S4).

After read of the next reception data (Step S60), the controller 12 determines whether the frame reception is complete or the number of read of reception data i has reached N₅ times (Step S70). If the frame reception is complete or the number of read of reception data i has reached N₅ times (YES at Step S70), the controller 12 releases the interrupt mask (Step S8). On the other hand, if the frame reception is not complete and the number of read of reception data i has not reached N₅ times (NO at Step S70), the controller 12 confirms the state of the buffer memory 112 again (Step S4). If the confirmation of the state of the buffer memory 112 is performed in the second round or more, the confirmation is performed in the second read process.

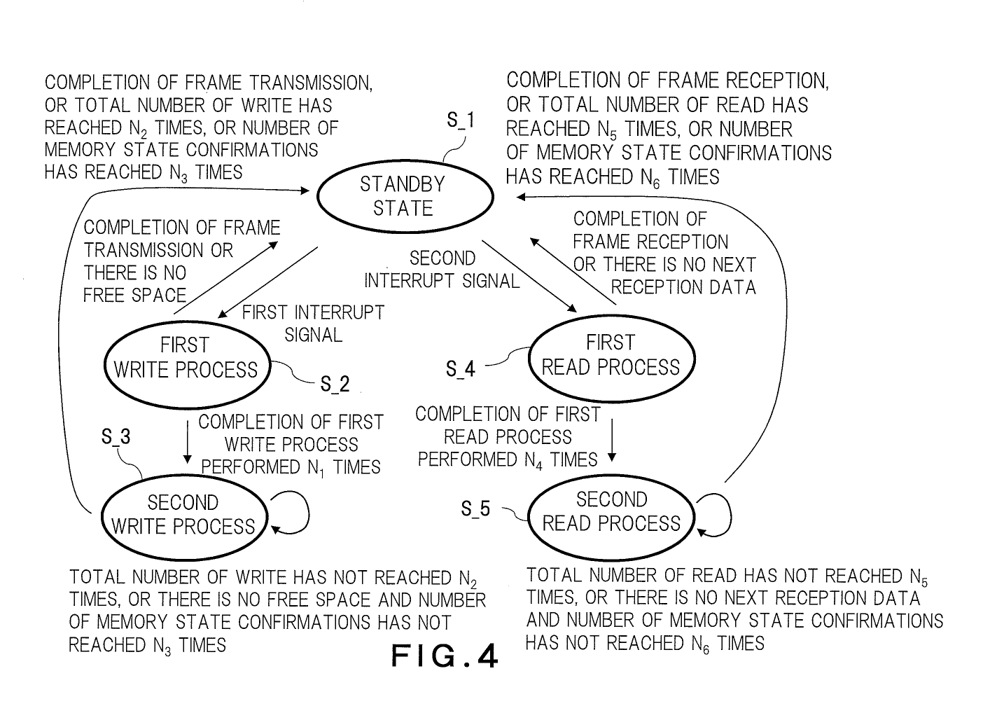

FIG. 4 is a state transition diagram of the controller 12 in the communication apparatus 10 of the communication system 1 shown in FIG. 1. As shown in FIG. 4, if the first interrupt signal is received in a standby state (S_1) waiting for the first write process and the first read process, the controller 12 shifts to a first write process state (S_2). The standby state (S_1) is a state where the controller 12 can execute tasks other than write and read with respect to the buffer memory 112. On the contrary, in the first write process state (S_2), if it is confirmed that the frame transmission is complete or the buffer memory 112 does not have a free space, the controller 12 shifts to the standby state (S_1).

Furthermore, in the first write process state (S_2), if the first write process is complete, the controller 12 shifts to a second write process state (S_3).

Further, in the second write process state (S_3), if the total number of write has not reached N₂ times, the controller 12 maintains the second write process state (S_3). If the buffer memory 112 does not have a free space and the number of state confirmations of the buffer memory 112 has not reached N₃ times, the controller 12 also maintains the second write process state (S_3).

On the other hand, in the second write process state (S_3), if the frame transmission is complete, the controller 12 shifts to the standby state (S_1). If the total number of write has reached N₂ times, the controller 12 also shifts to the standby state (S_1). If the number of state confirmations of the buffer memory 112 has reached N₃ times, the controller 12 also shifts to the standby state S_1).

Furthermore, as shown in FIG. 4, in the standby state (S_1), if the second interrupt signal has been received, the controller 12 shifts to a first read process state (S_4). On the contrary, in the first read process state (S_4), if it is confirmed that the frame transmission is complete or the buffer memory 112 does not have the next reception data, the controller 12 shifts to the standby state (S_1).

Further, in the first read process state (S_4), if the first read process is complete, the controller 12 shifts to a second read process state (S_5).

Further, in the second read process state (S_5), if the total number of read has not reached N₅ times, the controller 12 maintains the second read process state (S_5). If the buffer memory 112 does not have the next reception data and the number of state confirmations of the buffer memory 112 has not reached N₆ times, the controller 12 also maintains the second read process state (S_5).

On the other hand, in the second read process state (S_5), if the frame transmission is complete, the controller 12 shifts to the standby state (S_1). Further, if the total number of read has reached N₅ times, the controller 12 also shifts to the standby state (S_1). If the number of state confirmations of the buffer memory 112 has reached N₆ times, the controller 12 also shifts to the standby state (S_1).

The controller 12 shifts to the standby state, thereby enabling to execute tasks other than write and read with respect to the buffer memory 112.

If it is desired to give a priority to data transmission over reduction of the delay in execution of other tasks, N₃ times can be increased with a decrease of the transmission throughput. Further, if it is desired to give a priority to data reception over reduction of the delay in execution of other tasks, N₆ times can be increased with a decrease of the reception throughput.

As described above, according to the present embodiment, by selectively performing the first write process and the second write process, both the improvement of promptness of data transmission and the suppression of the delay in other processes can be achieved. Further, according to the present embodiment, by selectively performing the first read process and the second read process, both the improvement of promptness of data reception and the suppression of the delay in other processes can be achieved. That is, according to the present embodiment, both the improvement of promptness of data communication and the suppression of the delay in processes other than data communication can be achieved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A communication apparatus comprising:
a transmission device that reads transmission data to be transmitted to a communication counterpart apparatus from a buffer memory in which the transmission data is written, and transmits the transmission data to the communication counterpart apparatus; and
a controller that writes the transmission data in the buffer memory, wherein
the transmission device outputs a first interrupt signal to the controller in response to transmission completion of the transmission data, and
the controller can perform
a first write process in which the controller confirms a state of the buffer memory in response to the first interrupt signal, and if the buffer memory has a free space where next transmission data can be written, writes the next transmission data in the buffer memory at least once, and
a second write process in which the controller confirms the state of the buffer memory in response to completion of the first write process, and if the buffer memory has the free space, writes the next transmission data in the buffer memory, and wherein
the controller performs a new one of the first write process after having performed write of the transmission data in the second write process.

2. The apparatus of claim 1, wherein
the controller writes the next transmission data N₁ times (N₁ is a natural number, the same applies hereinafter) in the first write process, and
the controller performs the new first write process after having performed write of the transmission data N₂ times (N₂ is a natural number equal to or larger than N₁, the same applies hereinafter) in total in the first or second write process.

3. The apparatus of claim 2, wherein, when the controller has performed a confirmation of the state of the buffer memory N₃ times (N₃ is a natural number equal to or larger than N₁, the same applies hereinafter), if the buffer memory does not have the free space in all the confirmations performed N₃ times, the controller performs the new first write process without performing the second write process.

4. The apparatus of claim 3, wherein the controller acquires transmission throughput of the transmission device, and sets N₃ times to N₁+1 times, if the transmission throughput is higher than a first transmission threshold.

5. The apparatus of claim 4, wherein the controller sets N₃ times to N₁ times, if the transmission throughput is lower than a second transmission threshold, which is lower than the first transmission threshold.

6. The apparatus of claim 2, wherein
the transmission data is data in a unit of packet obtained by dividing a transmission frame whose transmission has been requested, into a plurality of packets, and
N₂ times indicates number of write of the transmission data required for transmission completion of the entire transmission frame.

7. A communication apparatus comprising:
a reception device that receives reception data received from a communication counterpart device, and writes the reception data in a buffer memory in which the reception data is written; and
a controller that reads the reception data from the buffer memory, wherein
the reception device outputs a second interrupt signal to the controller in response to reception completion of the reception data, and
the controller can perform
a first read process in which the controller confirms a state of the buffer memory in response to the second interrupt signal, and if the buffer memory has next reception data, reads the next reception data from the buffer memory at least once, and
a second read process in which the controller confirms the state of the buffer memory in response to completion of the first read process, and if the buffer memory has the next reception data, reads the next reception data from the buffer memory, and wherein
the controller performs a new one of the first read process after having performed read of the reception data in the second read process.

8. The apparatus of claim 7, wherein
the controller
reads the next reception data N₄ times (N₄ is a natural number, the same applies hereinafter) in the first read process, and
performs the new first read process after having performed read of the reception data N₅ times (N₅ is a natural number equal to or larger than N₄, the same applies hereinafter) in total in the first or second read process.

9. The apparatus of claim 8, wherein, when the controller has performed a confirmation of the state of the buffer memory N₆ times (N₆ is a natural number equal to or larger than N₄, the same applies hereinafter), if the buffer memory does not have the next reception data in all the confirmations performed N₆ times, the controller performs the new first read process without performing the second read process.

10. The apparatus of claim 9, wherein the controller acquires reception throughput of the reception device, and if the reception throughput is higher than a first reception threshold, sets N₆ times to N₄+1 times.

11. The apparatus of claim 10, wherein the controller sets N₆ times to N₄ times if the reception throughput is lower than a second reception threshold, which is lower than the first reception threshold.

12. The apparatus of claim 8, wherein
the reception data is data in a unit of packet constituting a reception frame, and
N₅ times is number of read of the reception data required for completion of read of last reception data in the reception frame from the buffer memory.

13. A memory control method comprising:
writing transmission data to be transmitted to a communication counterpart apparatus in a buffer memory, and reading the transmission data from the buffer memory to transmit the transmission data to the communication counterpart apparatus;
outputting a first interrupt signal in response to transmission completion of the transmission data;
performing write of the transmission data in a first write process in which a state of the buffer memory is confirmed in response to the first interrupt signal, and if the buffer memory has a free space where next transmission data can be written, the next transmission data is written in the buffer memory at least once;
performing write of the transmission data in a second write process in which the state of the buffer memory is confirmed in response to completion of the first write process, and if the buffer memory has the free space, the next transmission data is written in the buffer memory, and
performing a new one of the first write process after having performed write of the transmission data in the second write process.

14. The method of claim 13 comprising:
writing reception data received from a communication counterpart device in the buffer memory;
outputting a second interrupt signal in response to reception completion of the reception data;
performing read of the reception data in a first read process in which the state of the buffer memory is confirmed in response to the second interrupt signal, and if the buffer memory has next reception data, the next reception data is read from the buffer memory at least once;
performing read of the reception data in a second read process in which the state of the buffer memory is confirmed in response to completion of the first read process, and if the buffer memory has the next reception data, the next reception data is read from the buffer memory, and
performing a new one of the first read process after having performed read of the reception data in the second read process.
